(19) United States
(12) Patent Application Publication
(10) Pub. No.: US 2021/0226231 A1
(43) Pub. Date: Jul. 22, 2021

(54) Devices and Methods for Controlling A Fluid Module

(71) Applicant: Intelligent Energy Limited, Loughborough (GB)

(72) Inventor: Christopher James Gurney, Loughborough (GB)

(73) Assignee: Intelligent Energy Limited, Loughborough (GB)

(21) Appl. No.: 16/305,873

(22) PCT Filed: Aug. 3, 2018
(86) PCT No.: PCT/GB2018/052230

§ 371 Date: Nov. 29, 2018

(30) Foreign Application Priority Data
Nov. 29, 2017 (GB) 1719842.5

(51) Int. Cl. H01M 8/04029; H01M 8/0432; H01M 8/04701; H01M 8/0438; H01M 8/04007; H01M 8/04223; H01M 8/04119; H01M 8/04225; H01M 8/04302

(52) U.S. Cl. CPC H01M 8/04029; H01M 8/0432; H01M 8/04723; H01M 8/04417; H01M 8/04052; H01M 8/04074; H01M 8/04253; H01M 8/04134; H01M 8/04225; H01M 8/04302; H01M 8/04059

(57) ABSTRACT

Disclosed are methods and devices for controlling freezing of a cooling module for use in a fuel cell system. The cooling module includes a first chamber configured to receive a first material, a second chamber configured to receive a second material, and a first insulating layer disposed between the first chamber and the second chamber. The second chamber surrounds, at least partly, the first chamber. As ambient temperature decreases, the second material begins freezing before the first material begins freezing.

### TECHNICAL FIELD

This disclosure relates generally to fuel cell systems having fluid coolant storage tanks. Particularly, this disclosure is directed to methods and devices of controlling freezable coolant.

### BACKGROUND

Conventional electrochemical fuel cells convert fuel and oxidant into electrical energy and a reaction product. A common type of electrochemical fuel cell comprises a membrane electrode assembly (MEA), which includes a polymeric ion (proton) transfer membrane between an anode and a cathode and gas diffusion structures. The fuel, for example hydrogen, and the oxidant, for example oxygen from air, are passed over respective sides of the MEA to generate electrical energy and water as the reaction product. A stack may be formed comprising a number of such fuel cells arranged with separate anode and cathode fluid flow paths. Such a stack is typically in the form of a block comprising numerous individual fuel cell plates held together by end plates at either end of the stack.

### SUMMARY

Methods and devices for controlling a fuel cell system are disclosed. According to an aspect of the disclosure, a cooling module for use in a fuel cell system includes a first chamber configured to receive a first material, a second chamber configured to receive a second material, and a first insulating layer disposed between the first chamber and the second chamber. The second chamber surrounds, at least partly, the first chamber. As ambient temperature decreases, the second material begins freezing before the first material begins freezing.

According to another aspect, a method of delaying freezing of a first material in a fuel cell system includes the step of introducing the first material into a first chamber, introducing a second material into a second chamber, and maintaining the second material in a liquid state while allowing the first material to freeze or melt in response to decreased or increased ambient temperature. The second chamber is separated from the first chamber by a first insulating layer.

### BRIEF DESCRIPTION OF THE DRAWINGS

The present application is further understood when read in conjunction with the appended drawings. For the purpose of illustrating the subject matter, there are shown in the drawings exemplary implementations of the subject matter, however, the presently disclosed subject matter is not limited to the specific methods, devices, and systems disclosed. Furthermore, the drawings are not necessarily drawn to scale. In the drawings:

FIG. 1 illustrates a schematic diagram of a fuel cell system according to an aspect of the disclosure;

FIG. 2 illustrates a schematic diagram of a fuel cell system according to another aspect of the disclosure;

FIG. 3 illustrates a coolant module according to an aspect of the disclosure;

FIG. 4 illustrates a coolant module according to another aspect of the disclosure; and

FIG. 5 illustrates a flow chart depicting a process of operation of a fuel cell system.

### DETAILED DESCRIPTION OF ILLUSTRATIVE IMPLEMENTATIONS

Aspects of the disclosure will now be described in detail with reference to the drawings, wherein like reference numbers refer to like elements throughout, unless specified otherwise. Certain terminology is used in the following description for convenience only and is not limiting. The term “plurality.” as used herein, means more than one. The singular forms “a.” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When values are expressed as approximations by use of the antecedent “about,” it will be understood that the particular value forms another implementation. In general, use of the term “about” indicates approximations that can vary depending on the desired properties sought to be obtained by the disclosed subject matter and is to be interpreted in the specific context in which it is used, based on its function, and the person skilled in the art will be able to interpret it as such. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, reference to values stated in ranges includes each and every value within that range.

The disclosed fuel cell systems may be used in various environments. As such, it may be advantageous for the polymeric ion transfer membrane to remain hydrated for efficient operation. Due to produced heat, it may also be beneficial to control the temperature of the fuel cell stack. Thus, coolant may be supplied to the stack for cooling and/or hydration. Accordingly, a fuel cell system may include a coolant tank for hydration and/or cooling of the fuel cell stack. In some aspects, the coolant may include water, and the coolant tank may be a water tank. Although exemplary implementations described herein may teach using water as the coolant, it is understood that the disclosure is not limited to only water. While “water” and “coolant” may be used interchangeably throughout this disclosure, other suitable fluids and mixtures may comprise the coolant.

In some exemplary implementations, the fuel cell system may be stored or operated in environments with ambient temperatures below the freezing point of the coolant. For example, in some aspects, using water, the fuel cell system may be stored or operated at sub-zero Celsius temperature conditions, and the water in the fuel cell stack and water storage tank may freeze. The frozen water may cause blockages that hinder the supply of coolant or hydration water to the fuel cell stack. This is a particular problem when the fuel cell system is off and water in the water storage tank is no longer heated by its passage through the stack. The water may then freeze completely. In such an event, sufficient liquid water may not be available for hydration and/or cooling. As a result, the fuel cell assembly may be prevented from restarting or operating at full power until the frozen water has been thawed.

In some exemplary implementations, a heating element may be provided in the fuel cell system to melt frozen coolant. The heater may operate from a battery or another power source and maintain the fuel cell system at above-freezing temperatures to prevent freezing of the coolant/water. The heating element may include an electrical resistance heater.

In aspects utilizing battery power to operate the heating element, the battery power may be limited, and the fuel cell system may experience freezing if the battery fails or becomes discharged. As such, it may be advantageous to operate the heating element intermittently when liquid coolant is necessary, rather than at all times or in preset time cycles. Additionally, it may be advantageous to utilize heat generated by operation of the fuel cell system rather than a battery since batteries may experience low performance in cold temperatures. In some aspects, heat may be provided from an exhaust of the fuel cell system. The exhaust should be of sufficiently-high temperature so as to melt at least a portion of frozen material in the fuel cell system.

In some implementations, a fuel cell system may include a coolant module configured to receive and contain coolant, for example water. In some exemplary aspects where the coolant includes water and the fuel cell system is in a sub-zero Celsius temperature environment, the water in the module may freeze. When the fuel cell system is restarted, water from the module may be required for cooling the fuel cell stack and/or hydration of fuel cell membranes that form the fuel cells of the fuel cell stack. Some fuel cell systems lack a heating element to maintain an above-freezing temperature while the system is powered down. If the water in the coolant module is frozen, it must be thawed so that it is available to the fuel cell assembly.

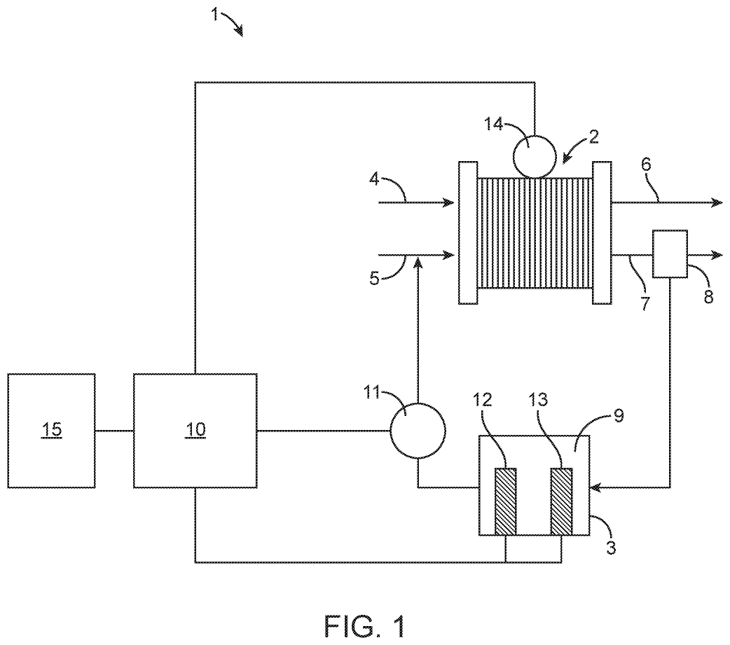

Referring to FIG. 1, a fuel cell system 1 may include a fuel cell assembly 2, a coolant module 3, and a pump 11. The coolant module 3 may include one or more coolant tanks 9. The pump 11 may be configured to move coolant from a coolant tank 9 of the coolant module 3 to the fuel cell assembly 2. The fuel cell assembly 2 may receive a flow of fuel, such as hydrogen, through an anode inlet 4 and a flow of oxidant, such as air, through a cathode inlet 5. An anode exhaust 6 may be disposed on the fuel cell assembly 2 and may be configured to allow the fuel to flow through the fuel cell assembly. A cathode exhaust 7 may be disposed on the fuel cell assembly 2 and may be configured to permit the oxidant to flow through the fuel cell assembly. It will be appreciated that the exhaust flows also carry reaction by-products and any coolant/hydration liquid that may have passed through the fuel cell assembly 2. The cathode exhaust 7 may include a coolant separator 8 to separate the coolant (e.g., water) from the cathode exhaust flow. The separated water may be stored in the coolant module 3. It will be appreciated that while this example shows the recycling of water coolant that has passed through the stack, this disclosure is applicable to systems that do not recycle coolant or recycle coolant in a different way.

The coolant module 3 may be connected to the fuel cell assembly 2 by conduits. Alternatively, the coolant module 3 may be integrated with the fuel cells in the stack. As shown in FIG. 1, the coolant module 3 may be connected to the cathode inlet 5 to allow for the introduction of coolant into the cathode flow for evaporative cooling of the fuel cell assembly 2. Alternatively, the coolant may be introduced to the fuel cell assembly by a separate conduit.

Flow of the coolant may be controlled by a coolant injection controller 10. The coolant injection controller 10 may form part of a fuel cell system controller 15 for controlling further operations of the fuel cell system. The coolant injection controller 10 may provide control signals to a pump 11 to control the delivery of water to the fuel cell assembly 2. The pump 11 may fluidly communicate with the coolant module 3 and the cathode inlet 5. The pump may include one or more pumping mechanisms typically used in flow fields, such as, but not limited to, peristaltic pumping, displacement pumping, and centrifugal pumping.

The controller 10 may also control one or more heating elements disposed on or within the coolant module 3. Referring to the illustrative implementation of FIG. 1, heating elements 12, 13, located in the coolant module 3, are electrically coupled with the coolant injection controller 10.

In some aspects, the heating elements 12, 13 may include a first heating element 12 and a second heating element 13 spaced from the first. The coolant module 3 may include a plurality of coolant tanks 9 configured to supply coolant to the fuel cell assembly. Each of the coolant tanks may have one or more heating elements. The one or more heating elements may be electrically powered or combustion-energy powered and may include a heat dissipating element, which may include a resistive heater or heat pipe or heat exchanger that moves heat from one part of the fuel cell system to another. In some implementations, for example, the compressors that drive oxidant through the fuel cell assembly heat up relatively quickly after start-up of the fuel cell assembly, and a heat exchange and working fluid and/or heat pipe may move heat from the compressors to the coolant module. In some aspects, exhaust that exits the fuel cell assembly at the cathode exhaust 7 is sufficiently warm. This exhaust may be used to provide heat to the coolant module and to heat the coolant therein, for example by convective means. Coolant may be heated by one or more other suitable heating methods, for example by microwave heating.

In some aspects, the fuel cell system 1 may include one or more sensors 14. The sensors 14 may communicate with the coolant injection controller 10 and may provide one or more measures of the performance of the fuel cell assembly 2.

In some exemplary implementations, the fuel cell system may be configured to detect the presence and/or the quantity of liquid coolant available in the coolant module. The fuel cell system may be stored or operated in a sub-freezing environment, and some or all of the coolant in the coolant module may be frozen. As detailed throughout this specification, one or more heating elements may be used to melt part or all of the frozen coolant, such that liquid coolant is available for use in cooling and/or hydrating the fuel cell assembly.

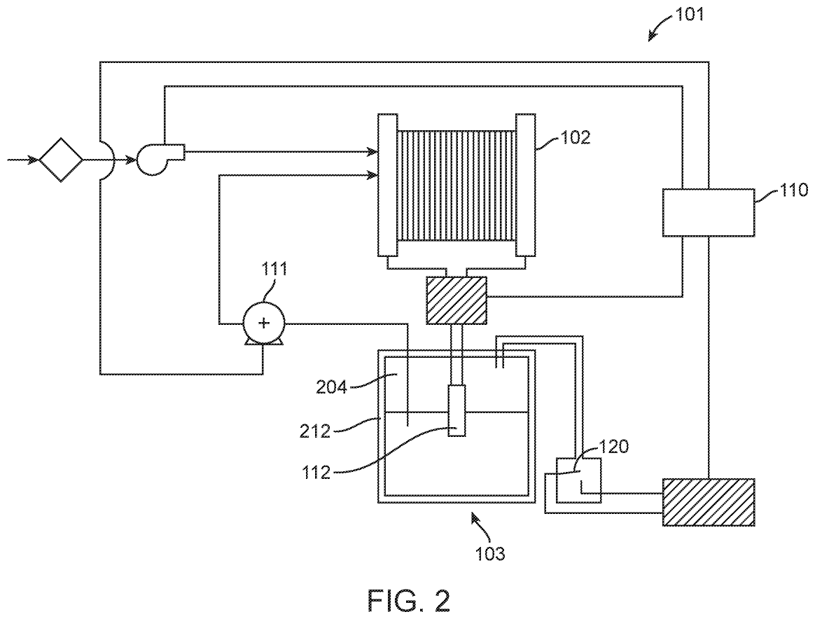

Referring to FIG. 2, the fuel cell system 101 may include a fuel cell assembly 102, which may be a fuel cell stack 102, a coolant module 103, a pump 111 fluidly communicating with the coolant module 103 and the fuel cell assembly 102, and one or more sensing instruments. The sensing instrument may be configured to detect and/or quantify the presence of melted (liquid) coolant, for example liquid water. The sensing instrument may detect presence of liquid coolant in the coolant module 103 and may transmit a command signal to a controller 110. In some aspects, the fuel cell system 101 may further include one or more heating elements 112 disposed on or within the coolant module 103 and configured to heat the coolant. The heating element 112 may be actuated to melt some or all of the coolant in the coolant module when liquid coolant is needed for operation of the fuel cell system.

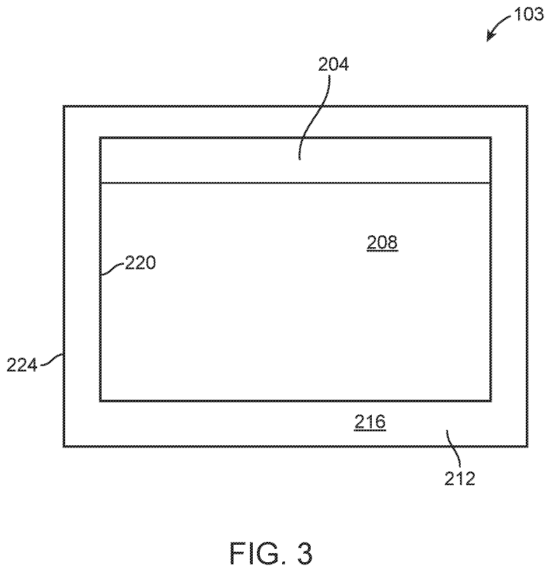

In some aspects, it may be advantageous to decrease the freezing of the coolant. FIG. 3 shows an implementation of the coolant module 103 having a first chamber 204 and a second chamber 212. The first chamber 204 may be at least partially inside the second chamber 212. As shown in the illustrative implementation of FIG. 3, the first chamber 204 is encapsulated inside the second chamber 212. In some instances at least one of the first chamber 204 and the second chamber 212 may be generally cylindrical, spherical, or prismatic. It will be understood that the shape of the first and second chambers may vary depending on application, scale, manufacturing constraints, preference, and other aspects. In some embodiments, it may be advantageous for the first chamber 204 and/or the second chamber 212 to be configured to expand and contract without cracking. In some instances when configured as spherical or cylindrical the containment chambers will have less seams than a polygon. As the second material 216 freezes, the second chamber 212 may expand; conversely, as the second material 216 melts, the second chamber 212 may contract.

The coolant module 103 includes a first insulation barrier 220 disposed between the first chamber 204 and the second chamber 212. The first insulation barrier 220 may be integral with the first chamber 204, and in some implementations, the first insulation barrier 220 defines the first chamber 204. In an alternative aspect, the first insulation barrier 220 is a separate component configured to contact the first chamber 204. The first insulation barrier 220 includes one or more materials useful for impeding or decreasing thermal conductance across them. It will be understood that the specific materials used may vary, and this disclosure is not limited to a particular insulation material. Suitable materials can include plastics, metals, and rubbers. In some aspects, the first insulation barrier 220 includes a vacuum between two materials.

Still referring to FIG. 3, the coolant module 103 may include a second insulation barrier 224 disposed adjacent the second chamber 212. The second insulation barrier 224 may include the same materials and thermal properties as the first insulation barrier 220. In some implementations, the coolant module 103 may include a third and a fourth insulation barrier.

A first material 208 may be disposed inside the first chamber 204. The first material 208 includes coolant as described throughout this application, for example water. The first material 208 can be transferred out of the first chamber 204 by the pump 111 to other components of the fuel cell system 101, such as the fuel cell assembly 102.

A second material 216 may be disposed inside the second chamber 212. The first material 208 and the second material 216 may include the same material and have the same consistencies. In some aspects, the second material 216 may include coolant, and the pump 11 may be configured to transfer the second material 216 from the second chamber 212 to the fuel cell assembly 102. The second chamber 212 including coolant may be advantageous as it provides an additional source of coolant beyond the coolant in the first chamber 204. The coolant in the second chamber 212 may be used as a backup source of coolant, for example, if the available coolant in the first chamber 204 is exhausted or is not in the proper physical state to be pumped.

In alternative implementations, the first and second materials 208, 216 may be different materials with different chemical and/or physical properties. The second material 216 has insulating properties that help prevent undesired temperature changes within the first chamber 204, the second chamber 212, or both chambers. The second material 216 may include a gel, for example an exothermic or endothermic gel. The exothermic gel may be configured to release heat when it undergos a phase change between a substantially solid and a substantially liquid phase. The system may be configured to trigger the phase change in the gel when the ambient temperature reaches a certain threshold. The phase change of the gel may be initiated by providing an electrical impulse or signal to the gel or an alternate initiation means. The gel may be configured to absorb heat from its surroundings when the temperature is raised above a certain threshold and use this heat to, at least partially, transition from one phase to another. In this implementation the gel is then ready to release the absorbed heat upon receiving an initiation signal and thus delay the freezing of the non-gel coolant. In some implementations, the second material 216 may have a higher thermal resistance than the first material 208. The second material 216 may have different thermal properties depending on the material's physical state of matter. For example, the second material 216 may have a higher thermal resistance when the second material is frozen than when it is liquid.

The second material 216 may have the same or higher freezing point than the first material 208, The system may be designed so that when the first and second materials are in an environment with decreasing temperature, the second material 216 begins to freeze before the first material 208 begins to freeze, this can be as a result of the difference in freezing points between the two materials or because the second material is arranged to surround the first material and so is exposed to the cold ambient conditions. When the second material 216 in the second chamber 212 freezes, it further insulates the first chamber 204 and the first material 208 therein. This insulation decreases the heat loss from the first material 208, which decreases quantity of first material 208 that freezes and the rate of freezing. This can decrease the likelihood of the coolant module 103 having insufficient liquid coolant available for operating the fuel cell system 101. By configuring the coolant module 103 to have the second material 216 in the second chamber 212 freeze and further insulate the first material 208 in the first chamber 204, the coolant module 103 can be stored and/or operated in a colder environment than some existing technology.

Components of the fuel cell system 101 may be disposed within or adjacent to the coolant module 103. The heating element 112 may be disposed inside the first chamber 204 such that it can heat the first material 208. The heating element 112 may alternatively, or additionally, be disposed inside the second chamber 212 such that it can heat the second material 216. The heating element 112 may be disposed on or within the first insulation barrier 220. In some implementations, the second insulation barrier 224 may include a heating element 112. The heating element 112 may be configured to heat only the material to which it is adjacent. Alternatively, the heating element 112 may be disposed such that it can provide heat to the first material 208 and to the second material 216 simultaneously.

In some implementations, the heating element 112 may be configured to provide heat only to the first chamber 204 such that the first material 208 is in a liquid state while not directly providing heat to the second chamber 212 such that the second material 216 is allowed to freeze. If the first material 208 and the second material 216 are partially or entirely frozen, the controller 110 may provide a specific set of instructions to one or more heating elements 112 to generate heat such that the first and second materials 208, 216 are melted in a desired order.

The presence and/or quantity of liquid coolant in the coolant module 103 may be determined by one or more sensing instruments. The sensing instrument may detect presence of liquid coolant in the coolant module 103 and transmit a command signal to a controller 110. The controller 110 may actuate the pump 111 to move melted coolant from the coolant module 103 to the fuel cell assembly 102. In some implementations, the controller 110 may transmit a command signal to the one or more heating elements 112 to either actuate the heating elements to heat the coolant or to terminate heating of the heating elements.

The sensing instrument may include an electromechanical switch 120, which may be, or operatively couple to, a thermometer configured to detect a temperature change of the coolant in the coolant module 103. As the frozen water melts, a portion of the liquid water evaporates to form water vapor. Thus, in some aspects, the thermometer detects and quantifies an increase in temperature of the vapor generated by heating the coolant. The thermometer may be a bimetallic thermometer configured to actuate the electromechanical switch 120 when the temperature of either the coolant inside the coolant module or the vapor formed from evaporated coolant is greater than a predetermined temperature threshold as indicated by the bimetallic thermometer. The predetermined threshold temperature of water vapor may correspond to a desired amount of melted water. In some aspects, the electromechanical switch 120 may include an electrical circuit with a bridge configured to open or close the circuit when a temperature threshold is reached.

The sensing instrument may include a pressure sensor 126 configured to detect and quantify vapor pressure in the fuel cell system 101. As more coolant is melted by the heating element 112, more liquid coolant is evaporated into vapor. When the vapor pressure is greater than a predetermined pressure threshold as indicated by the pressure sensor 126, the pressure sensor 126 transmits a command signal to the controller 110.

The sensing instrument may include a strain gauge 124 configured to measure the expansion or contraction of a portion of the fuel cell system 101, such as the coolant module 103. As coolant freezes, the volume of coolant expands; conversely, when frozen coolant melts, the total volume of coolant contracts. The strain gauge 124 detects and measures the amount of expansion and contraction due to the respective freezing and melting of the coolant and transmits a signal to the controller 110. As with the other implementations disclosed herein, it will be understood that the predetermined strain threshold may vary and may be determined based on the desired quantity of liquid coolant in the coolant module 103.

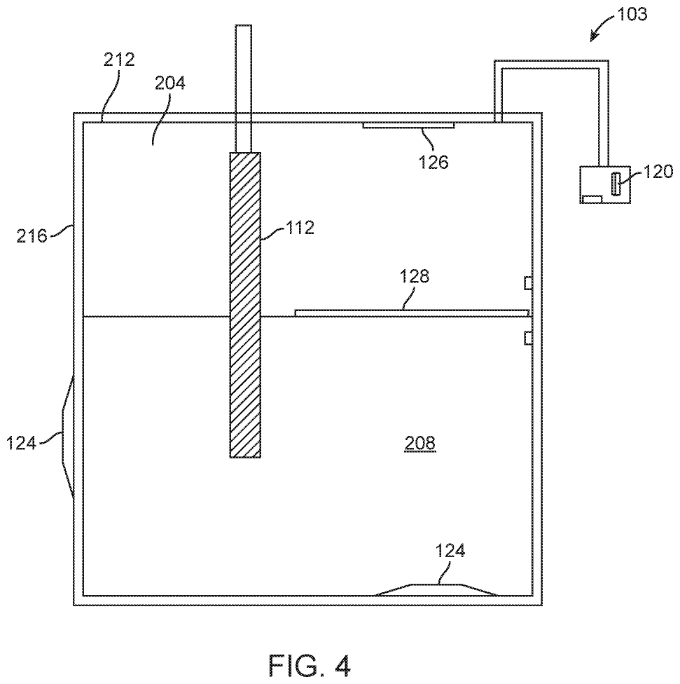

The sensing instrument may include a float 128 disposed within one or more components of the fuel cell system 101, such as the coolant module 103. The float 128 includes material that is less dense than coolant used in the fuel cell system when the coolant is either in a solid or a liquid state, and so the float 128 is always configured to be on the surface of the volume of frozen or melted coolant. When coolant freezes, the total volume of coolant may expand; conversely, when coolant melts, the total volume may contract. The float 128 is configured to move in a first direction as coolant expands and in a second direction opposite the first direction when coolant contracts. Referring to FIG. 4, the float 128 may be disposed inside the coolant module 103, such that when the coolant (e.g., water) freezes, the float 128 moves vertically up in the coolant module, and when coolant melts, the float 128 moves vertically down. The float 128 may be mechanically or electrically coupled to the controller 110, and it may transmit a signal to the controller that corresponds to the distance and direction of movement of the float 128. The float 128 may be disposed in the first chamber 204, in the second chamber 212, or in both the first and the second chambers 204, 212.

The controller 110 may be configured with a program to convert the signals received from the strain gauge, the pressure sensor, the bimetallic thermometer, the float, or another measurement instrument, and the coolant injection controller may receive multiple signals from one or more sensing instruments. The program may include predetermined thresholds for each measurement instrument described herein, and the program may be modifiable by a user. The program may further transmit command signals to other components of the fuel cell system, such as the heating element, the pump, or another system controller.

One or more sensing instruments as described throughout this application may be disposed in the first chamber 204, in the second chamber 212, or in both chambers. The sensing instruments may be disposed adjacent or within the first insulation barrier 220, the second insulation barrier 224, or a combination of multiple insulation barriers.

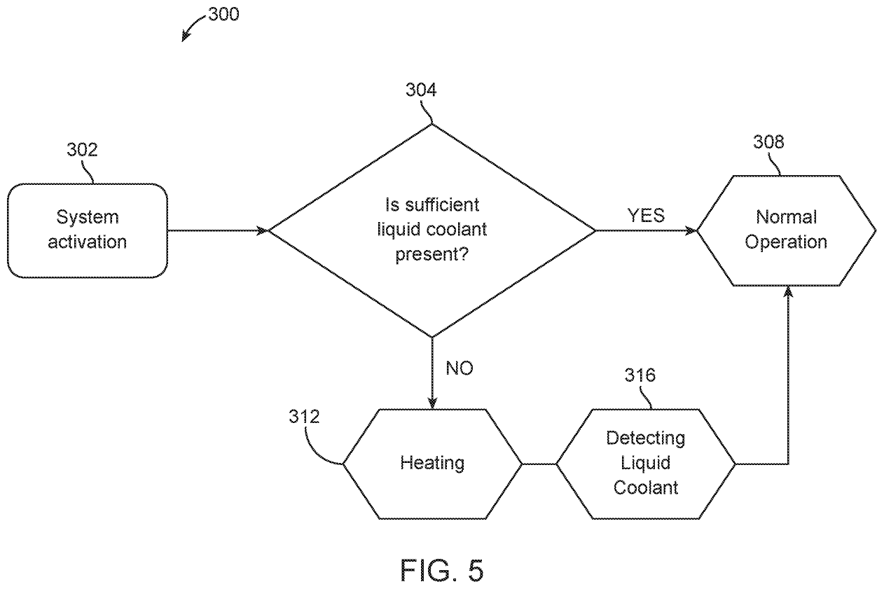

An exemplary process 300 of ensuring liquid coolant is available in the coolant module 103 is shown in FIG. 5. The process may be performed by the fuel cell system controller 110. The process of operation is performed to enable the fuel cell system to effectively start when used in cold or freezing ambient conditions. In cold or freezing ambient conditions, there is a risk that coolant required by the fuel cell assembly 102 may not be available because it is frozen in the coolant module 103. It is important for the fuel cell system to identify when there may be an insufficient amount of coolant available and to modify its operation accordingly to enable reliable start-up of the fuel cell system. This is particularly important when the fuel cell system 101 provides the motive power for a vehicle. A user of the vehicle will expect the fuel cell system to reliably start and be able to provide effective power for the vehicle in a wide range of operating environments. This is a challenge given that resources, such as coolant, that are required by the fuel cell assembly for efficient operation may not be, at least initially, available for use.

As shown in FIG. 5, the fuel cell system 101 is turned on in block 302 to operate the fuel cell assembly 102. This may include powering up of electrical systems, such as the controller 110 and other components. This may initiate a supply of fuel and oxidant to the fuel cell assembly 102.

Referring to block 304, the controller 110 determines the presence of liquid coolant in the first chamber 204 with one or more sensing instruments as described herein. If sufficient liquid coolant is available, the process proceeds to block 308, where the controller 110 actuates the pump 111 to pump coolant out of the first chamber 204 to the fuel cell assembly 102 or to another component in the fuel cell system 101.

If there is insufficient liquid coolant available, the process instead moves to block 312 from block 304. In block 312, the controller 110 may actuate the heating element 112 to provide sufficient heat to the first chamber 104 such that the first material 208 melts. Once heating begins, the process monitors and detects when sufficient liquid coolant is available, for example via one or more sensing instruments, in block 316. When a sufficient amount of liquid coolant is present, the process proceeds to block 308, where the pump 111 can begin to move liquid coolant and fuel cell system 101 operates normally.

A fuel cell coolant module with a freezable material in a second chamber helps prevent, or at least delay, freezing of coolant in the first chamber. This allows the fuel cell system to be operated in colder environments. Added insulation increases thermal resistance of the coolant module exterior, and less heat energy is lost to the outside environment from the coolant in the first chamber. In some aspects, for example, about 200 g of freezable water provides heat protection to the coolant similar to heat produced from about 18.5 hours of operation of a 1 W heating element.

Liquid coolant may also be available faster and longer, allowing for quicker transition from an “off” or “stand-by” configuration to normal operation of the fuel cell system. Decreasing and/or delaying freezing of coolant requires less heating to melt and/or heat the coolant necessary for pumping. This saves on energy used to power the heating elements and reduces deterioration and wear-and-tear of the heating element.

The coolant module disclosed herein may be a separate unit, or it may be used with existing fuel cell systems. In some implementations, the coolant module 103 may replace an existing coolant module. This would increase efficiency of the fuel cell system without the need to manufacture entire systems.

Cracks and deterioration of containers and related components are often associated with expansion due to freezing and contraction due to thawing. Reduced freezing and thawing lessens stress on the coolant module and other components, prolonging their lifespans and lowering costs associated with frequent maintenance and replacements.

Methods are disclosed of delaying freezing of a first material 208, for example of a coolant. The first material 208 is first introduced into the first chamber 204 of the coolant module 103. The second chamber 212 may receive the second material 216 in it. The second material 216 may then be allowed to freeze in the second chamber 212 to form an insulation layer around the first chamber 204. This helps delay or prevent freezing of the first material 208 in the first chamber 204. The first chamber 204, the second chamber 212, or both chambers can be heated with one or more heating elements 112 to control temperature of the respective materials within.

The heating element 112 may be used to melt the first or second material 208, 216, and it may be used to control and maintain a desired temperature. A sensing instrument, for example a thermometer, may be used to detect and indicate the temperature of the first chamber 204 and the second chamber 212.

Although labeled with different reference numerals, it will be understood that descriptions of individual components and elements as they apply to a particular implementation may apply to all implementations unless explicitly stated otherwise.

While the disclosure has been described in connection with the various aspects of the various figures, it will be appreciated by those skilled in the art that changes could be made to the aspects described above without departing from the broad inventive concept thereof. It is understood, therefore, that this disclosure is not limited to the particular aspects disclosed, and it is intended to cover modifications within the spirit and scope of the present disclosure as defined by the claims.

Features of the disclosure that are described above in the context of separate implementations may be provided in combination in a single implementation. Conversely, various features of the disclosure that are described in the context of a single implementation may also be provided separately or in any sub-combination. Finally, while an implementation may be described as part of a series of steps or part of a more general structure, each said step may also be considered an independent implementation in itself, combinable with others.

1. A cooling module for use in a fuel cell system, the cooling module comprising:
a first chamber configured to receive a first material;
a second chamber configured to receive a second material; and
a first insulating layer disposed between the first chamber and the second chamber,
wherein the second chamber at least partly surrounds the first chamber, and
wherein, upon a decrease in ambient temperature, the second material begins freezing before the first material begins freezing.

2. The coolant module of claim 1, wherein at least one of the first and second material is water.

3. The coolant module of claim 1, wherein at least one of the first and second material is an exothermic gel.

4. The coolant module of claim 1 further comprising a second insulation surrounding the cooling module.

5. The coolant module of claim 1 further comprising at least one heating element in fluid communication with the first material.

6. The coolant module of claim 1 further comprising at least one heating element in fluid communication with the second material.

7. The coolant module of claim 5 or 6, further comprising:
at least one temperature sensor;
a controller in signal communication with the at least one temperature sensor,
wherein the controller controls the power provided to the at least one heating element in response to temperature data as indicated by the at least one temperature sensor.

8. The coolant module of claim 7, wherein the at least one temperature sensor includes a bimetallic switch.

9. The coolant module of claim 7, wherein the controller is configured to heat at least one of the first material and the second material until a predetermined temperature set point is reached as indicated by the temperature sensor.

10. The coolant module of claim 7, wherein the at least one heating element includes an electrical resistance heater.

11. The coolant module of claim 7, wherein the at least one heating element includes exhaust from the fuel cell system, the exhaust being of sufficient temperature to melt at least a portion of at least one of the first material and the second material.

12. The coolant module of claim 7, further comprising a strain gauge configured to detect a change in quantity of the frozen physical state of at least one of the first material and the second material.

13. The coolant module of claim 7, further comprising a pressure sensor configured to detect a pressure change of the vapor state of at least one of the first material and the second material.

14. The coolant module of claim 7, further comprising a float configured to move in a first direction and a second direction opposite the first direction in response to change in the quantity of the frozen physical state of at least one of the first material and the second material.

15. The coolant module of claim 12, wherein the second chamber is configured to expand and contract without cracking, the second chamber expanding when the second material freezes and contracting when the second material melts.

16. The coolant module of claim 15, wherein the second chamber is one of a spherical second chamber and a cylindrical second chamber.

17. A method of delaying freezing of a first material in a fuel cell system, the method comprising the steps of:
introducing the first material into a first chamber;
introducing a second material into a second chamber, the second chamber being separated from the first chamber by a first insulating layer; and
maintaining the second material in a liquid state while allowing the first material to freeze or melt in response to decreased or increased ambient temperature.

18. The method of delaying freezing of a first material in a fuel cell system of claim 17, further comprising the step of heating the second chamber with a heating element.

19. The method of delaying freezing of a first material in a fuel cell system of claim 18, further comprising the step of heating the first chamber with a heating element.

20. The method of delaying freezing of a first material in a fuel cell system of claim 17, further comprising the step of maintaining a desired temperature in at least one of the first chamber and the second chamber using a temperature sensor, such that at least one of the first material and the second material is in the liquid physical state.
